(19) United States
(12) Patent Application Publication
(10) Pub. No.: US 2012/0229264 A1
(43) Pub. Date: Sep. 13, 2012

(54) SMART LINEAR RESONANT ACTUATOR CONTROL

(75) Inventors: Enrique Company Bosch, Alginet (ES); Javier Calpe Maravilla, Algemesi (ES); Santiago Iriarte, Valencia (ES); Eoghan Moloney, Raheen (IE); Krystian Balicki, Limerick (IE); Mark Murphy, Kilmore (IE); Eoin Edward English, Pallasgreen (IE); Pedro Lopez Canovas, Valencia (ES)

(73) Assignee: ANALOG DEVICES, INC., Norwood, MA (US)

(21) Appl. No.: 13/219,353

(22) Filed: Aug. 26, 2011

Related U.S. Application Data
(60) Provisional application No. 61/450,824, filed on Mar. 9, 2011.

(51) Int. Cl. G08B 6/00

(52) U.S. Cl. 340/407.1

(57) ABSTRACT

The present invention provides a haptics control system that may include a driver to generate a continuous drive signal and to output the drive signal to a mechanical system on an electrical signal line, wherein the continuous drive signal causes the mechanical system to vibrate to produce a haptic effect. The haptics control system may further include a monitor, coupled to the electrical signal line, to capture a Back Electromotive Force (BEMF) signal generated by the mechanical system in the electrical signal line, to measure a BEMF signals attribute, and to transmit an adjustment signal to the driver based on the BEMF signals attribute. The driver is further configured to adjust the continuous drive signal according to the adjustment signal.

This application benefits from the priority of provisional application Ser. No. 61/450,824, filed Mar. 9, 2011.

### BACKGROUND

The present invention relates to generating haptics effects.

Haptics refers to the sense of touch. In electronic devices, haptics relates to providing a touch sensory feedback to the user. Electronic devices incorporating haptics may include cell phones, PDAs, gaming devices, etc. The user interacts with electronic devices through a user interface, such as a touch screen; however, without some kind of feedback, the user often does not know if the user's desired function was recognized or is being performed by the electronic device. Thus, electronic devices may generate an audio or haptic feedback in the form of a vibro-tactile sensation (e.g. a “simulated click”) to alert the user of the electronic device's performance. Stated differently, haptic feedback lets the user know what is going on with the electronic device. In a gaming electronic device, for example, haptics can provide sensory stimuli according to game interactions.

Haptic feedback can be generated by electro-mechanical systems. An electrical system produces a drive signal that will then cause a mechanical system to produce the haptic effect. For example, an actuator incorporating a moving mass can be used to generate haptic effects. A linear resonant actuator (LRA) is an example of one such actuator in which a moving mass is spring loaded. For optimal and efficient haptic generation using an LRA the spring loaded mass should be driven at its mechanical resonant frequency, which is the natural vibration frequency of the spring loaded mass. Also, the “volume” of the haptic effect may be controlled by the amplitude of the actuator driving signal.

BEMF (Back Electromotive Force) can be used to optimally program the drive signal at the mechanical resonant frequency and at the desired amplitude. BEMF is an electrical signal that is induced into the electrical connections of the motor by the movement of a permanent magnet (which has a mass) relative to a stationary wire wound coil. Since the mass will vibrate at the natural resonant frequency, the BEMF signal induced will also propagate at this resonant frequency.

In some conventional systems, a separate coil is used to capture the BEMF. The BEMF coil, which is not part of the driving coil that energizes the mass, captures the BEMF produced by the mass. However, these systems require extra designated parts such as the BEMF coil specifically for capturing the BEMF, which result in larger electronic devices. Some other conventional systems use a discontinuous drive signal to capture the BEMF signal. These systems' drive signals are stopped at predetermined times so there is no current being applied to the motor during these times. The BEMF can then be captured from the drive signal coil at those predetermined times. Therefore, there is a constant switching between applying the drive signal and measuring the BEMF signal. The constant switching results in less energy being applied to the mechanical system, reducing the quality of the overall haptic effect. The predetermined times also limits the range of frequencies that the drive electronics can tolerate.

Accordingly, the inventors recognized a need in the art for an adaptive haptic effect generation that could capture the BEMF signal with a continuous drive signal application without the requirement for extraneous parts.

### BRIEF DESCRIPTION OF THE DRAWINGS

FIG. 1(a) is a simplified block diagram of a smart LRA drive system according to an embodiment of the present invention.

FIG. 1(b) is a simplified diagram of an electric-magnetic motor according to an embodiment of the present invention.

FIG. 1(c) is an electrical model of a motor according to an embodiment of the present invention.

FIG. 2 is a simplified process flow method to generate a haptic effect according to an embodiment of the present invention.

FIG. 3 is a simplified block diagram of a BEMF monitor according to an embodiment of the present invention.

FIG. 4 is a simplified circuit of a BEMF monitor according to an embodiment of the present invention.

FIG. 5 is a simplified circuit of a BEMF monitor according to an embodiment of the present invention.

FIG. 6 is a simplified circuit of a BEMF monitor according to an embodiment of the present invention.

FIG. 7 is a simplified circuit of a BEMF monitor according to an embodiment of the present invention.

FIG. 8 illustrates a timing graph.

FIG. 9(a) illustrates a timing graph.

FIG. 9(b) illustrates a timing graph.

FIG. 10 illustrates a timing graph.

FIG. 11(a) is a simplified circuit diagram of a dual mode driver according to an embodiment of the present invention.

FIG. 11(b) is a simplified circuit diagram of a dual mode driver according to an embodiment of the present invention.

FIG. 11(c) is a simplified circuit diagram of a dual mode driver according to an embodiment of the present invention.

FIG. 12 is a simplified circuit diagram of a dual mode driver according to an embodiment of the present invention.

FIG. 13 illustrates a timing graph.

FIG. 14 is a simplified diagram of smart LRA driver input system according to an embodiment of the present invention.

FIG. 15 illustrates drive signal profiles according to embodiments of the present invention.

FIG. 16 illustrates drive signal profile according to embodiment of the present invention.

FIG. 17 illustrates drive signal profile according to embodiment of the present invention.

FIG. 18 is a simplified block diagram of a smart LRA drive system according to an embodiment of the present invention.

FIG. 19(a) is a simplified block diagram of an LRA drive system according to another embodiment of the present invention.

FIGS. 19(b) and (c) are graphs showing AC transfer functions of an LRA drive system with and without bridging capacitors.

FIG. 20 is a simplified block diagram of a BEMF monitor system according to another embodiment of the present invention.

FIG. 21 illustrates a method according to an embodiment of the present invention.

### DETAILED DESCRIPTION

Embodiments of the present invention provide a haptics control system that includes a driver to generate a continuous drive signal to an output pin. The haptics control system also includes a monitor, coupled to the output pin, to capture a Back Electromotive Force (BEMF) signal generated thereon, to measure a BEMF signal attribute, and to transmit an adjustment signal to the driver based on the BEMF signal attribute. The driver is configured to adjust the continuous drive signal generation according to the adjustment signal.

Embodiments of the present invention also provide a method to generate a haptic effect. The method may include generating a continuous drive signal; applying the continuous drive signal to an actuator via a signal line, wherein the continuous drive signal vibrates the actuator to generate a haptic effect; capturing a BEMF signal generated by the actuator on the signal line during the application of the continuous drive signal; measuring a BEMF signal property from the BEMF signal; and adjusting a corresponding continuous drive signal property based on the measured BEMF signal property.

Embodiments of the present invention further provide an electronic device including a haptics controller to generate instructions based on a desired haptic effect, and a driver to receive the instructions and generate a continuous drive signal. The electronic device also includes a linear resonant actuator, coupled to the driver, to receive the continuous drive signal from the driver via a signal line and to vibrate a mass within the linear resonant actuator thereby generating the desired haptic effect. A monitor captures a BEMF signal produced by the vibration on the signal line, to measure a BEMF signal property. The driver is configured to adjust the generation of the continuous drive signal based on the measured BEMF signal property.

The invention provides a smart linear resonant actuator (LRA) drive scheme for haptic generation that applies a continuous drive signal. The continuous drive signal is applied to a motor that mechanically generates the desired haptic effect. This drive scheme also allows for the monitoring of a BEMF signal induced by the motor while the continuous drive signal is applied. In other words, the drive signal is applied and the BEMF is monitored simultaneously. The resonant frequency and/or the amplitude of the motor's vibration may be measured from the BEMF signal. Based on the measurements, the continuous output drive signal may be adjusted accordingly

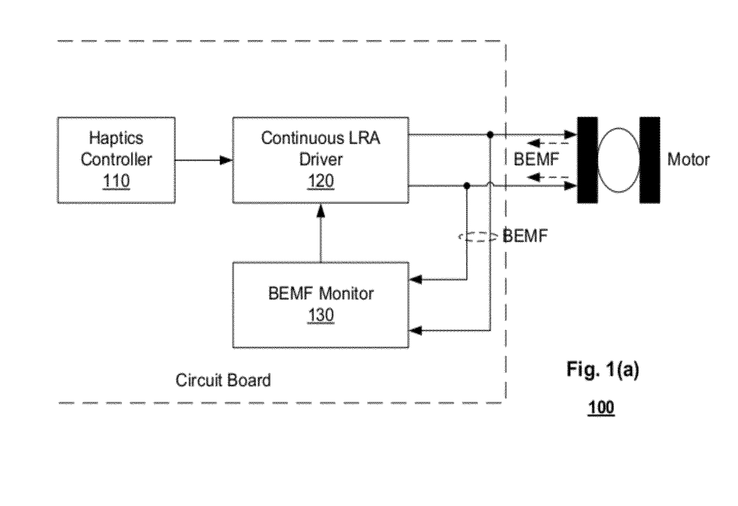

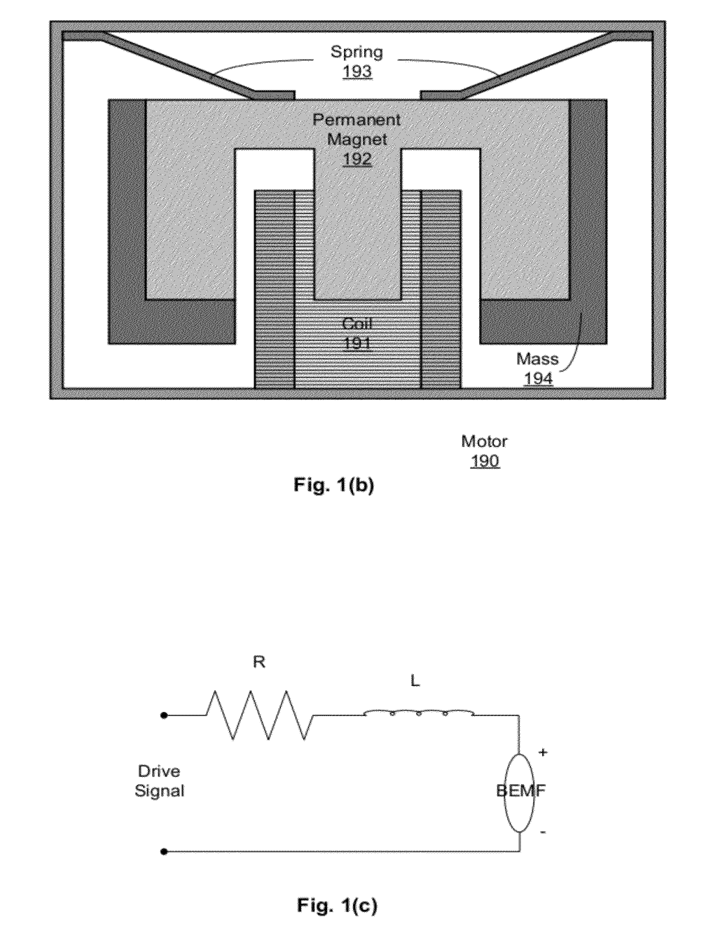

FIG. 1(a) is a simplified block diagram of smart LRA drive system 100 according to an embodiment of the present invention. The system 100 may include a haptics controller 110, a continuous LRA driver 120, and a BEMF monitor 130. The continuous LRA driver 120 may be coupled to a motor via a signal line. The continuous LRA driver 120 may include an output pin to which the motor is coupled. The signal line may be a pair of electrical lines, and the output pin may include a pair of pins for differential signals. The BEMF monitor 130 may also be coupled to the signal line.

According to a haptic effect request, the haptics controller 110 may generate a corresponding control signal output to the continuous LRA driver 120. For example, a user may select an icon on a touch screen, and the haptic controller 110 may generate a control signal corresponding to a haptic effect such as a clicking vibration for feedback stimulation to the user for his/her selection. The haptics controller 110 may provide a plurality of different haptic effects. The continuous LRA driver 120 may receive the control signal from the haptic controller 110 and may generate a drive signal accordingly. The drive signal may be continuous. Further, the drive signal may vary ±Δ, where Δ is the drive signal's amplitude.

The continuous LRA driver 120 may output the generated drive signal to the motor where the drive signal may cause the motor to vibrate and, thus, generating the haptic effect. The drive signal may be outputted to an output pin by the continuous LRA driver 120, and the motor may also be coupled to the output pin.

The motor may include a coil motor with a spring loaded mass. The motor may include a permanent magnet. The motor may cause the spring loaded mass to vibrate to generate the haptic effect. The motor may also include magnetic coils to generate the motion. Moreover, the vibration by the motor may induce a BEMF signal to be produced in the electrical signal lines coupled to the motor. The BEMF signal's frequency may correspond to the mechanical system's resonant frequency, and the BEMF signal's amplitude may correspond to the mechanical system's vibration magnitude.

FIG. 1(b) is a simplified block diagram of an electro-magnetic motor 190 that may be used in the present invention. The motor may include a coil 191, a permanent magnet 192, a spring 193, and a mass 194. The coil 191 may be coupled to the drive signal output.

Returning to FIG. 1(a), the BEMF monitor 130 may capture the BEMF signal from the electrical signal lines that are used to apply the drive signal to the motor. The BEMF monitor 130 may be coupled to the same output pin to where the continuous LRA driver 120 outputs the drive signal and to where the motor is coupled. Since the drive signal may be a continuous signal, the BEMF monitor 130 may separate the BEMF signal from the drive signal. After separating the BEMF signal, the BEMF monitor 130 may measure the BEMF signal's frequency and/or amplitude. The BEMF monitor 130, according to the measurement values, may transmit an adjustment signal to the LRA driver 120. The LRA driver 120 may then adjust the drive signal's frequency and/or amplitude in order to produce an optimum drive signal.

Unlike some prior art systems, the system 100 does not pause or stop the drive signal when it captures the BEMF signal on the same signal lines as the drive signal. Moreover, the system 100 does not include separate coils or lines to capture the BEMF signal, but captures the BEMF signal on the same line as the drive signal simultaneous with drive signal application.

The haptics controller 110, continuous LRA driver 120, and BEMF monitor 130 may be fabricated on separate integrated circuits or may be combined in a common integrated circuit. For example, the continuous LRA driver 120 and the BEMF monitor 130 may be fabricated on a single integrated circuit. The integrated circuit(s) may be placed on a circuit board, for example a printed circuit board (PCB).

To understand the operation of the present invention, consider FIG. 1(c), which illustrates an electrical model of the motor. The motor may be represented by three electrical components. A resistive component R represents a resistance in the motor. An inductive component L represents an inductance in the motor. A BEMF component represents an electrical signal generated by the motor's motion. Thus, the voltage seen at the motor may be characterized by:

$$V = Ri + L \frac{d i}{d t} + \frac{d λ}{d t} ,$$

where R is the resistance component in the motor, i is the current, L is the inductor component in the motor,

$$\frac{d i}{d ι}$$

is the rate of change of the current, λ is the magnetic flux, and

$$\frac{d λ}{d \text{?}}$$

$$\text{?} \text{indicates text missing or illegible when filed}$$

is the BEMF. The BEMF may be further defined as:

$${e}_{m} = \frac{d λ}{d t} = {K}_{g} v ,$$

where K_{g} is an EMF constant and v is the velocity.

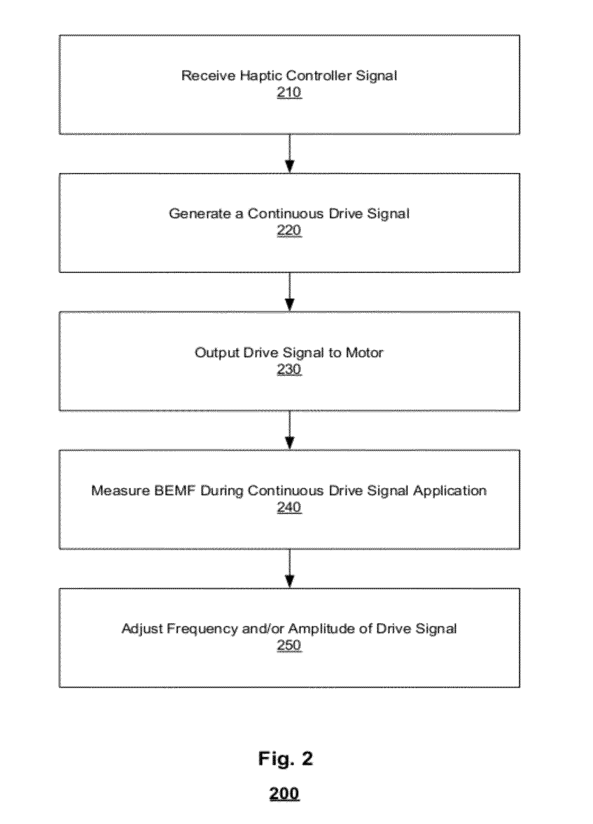

FIG. 2 illustrates a method 200 to generate a haptic effect according to an embodiment of the present invention. Initially, a haptic control signal may be received (Block 210). The haptic control signal may include information regarding the characteristics of the desired haptic effect. Characteristics may include the type of haptic effect, duration of haptic effect, etc. Next, a drive signal may be generated according to the haptic control signal (Block 220). The drive signal may be a continuous signal. For example, the drive signal may be a pulse modulated signal, which is a continuous signal.

The generated drive signal may be outputted to a motor (Block 230). The drive signal may excite the motor into motion, which will cause a mass in the motor to vibrate according to the drive signal's profile. The vibration of the mass causes the haptic effect that is felt by the user. The vibration also may induce a BEMF signal in the electrical lines that applied the drive signal to the motor.

During the continuous drive signal application to the motor, the BEMF signal may be measured (Block 240). The BEMF signal may be captured in the electrical lines that applied the drive signal. The BEMF signal may be separated from the drive signal because the drive signal is also captured with the BEMF in the electrical lines since the drive signal is continuous. BEMF signal is usually a low frequency signal. Upon separation of the BEMF signal, the frequency and/or amplitude of the BEMF signal is measured. The BEMF signal's frequency may correspond to the mechanical system's resonant frequency, and the BEMF signal's amplitude may correspond to the mechanical system's vibration magnitude.

The drive signal's frequency and/or amplitude may be adjusted (Block 250). In a feedback manner, the drive signal's profile may be adjusted according to the BEMF measurement. In an optimal system, the drive signal's frequency will be at the mechanical system's resonant frequency, its amplitude will be at the desired haptic effect magnitude.

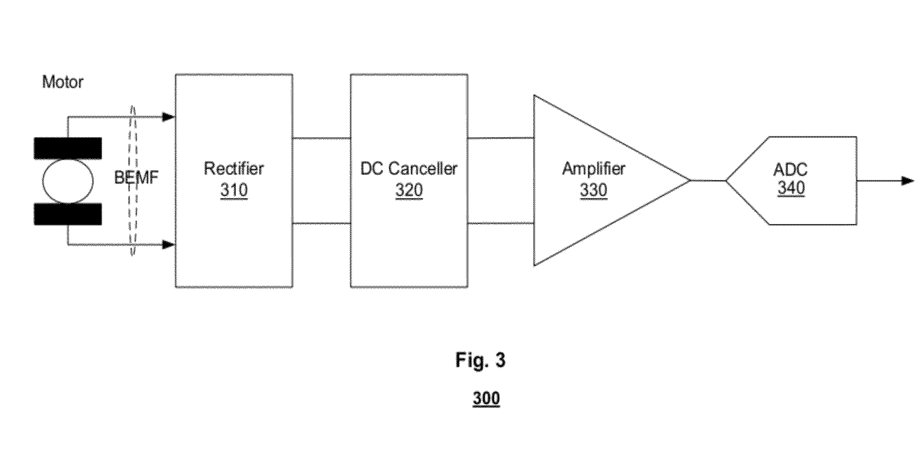

FIG. 3 is a simplified block diagram a BEMF monitor 300 according to an embodiment of the present invention. The BEMF monitor 300 may receive an input signal from a connected actuator/motor. Also, the BEMF monitor 300 may capture the BEMF signal while a continuous drive signal is applied to the connected motor. The BEMF monitor 300 may include a rectifier 310, a DC canceller 320, an amplifier 330, and an analog-to-digital converter (ADC) 340.

The rectifier 310 may invert the negative phases of the input signal. Thus, the rectified signal may always be a positive voltage. The DC canceller 320 may remove the DC offset in the rectified input signal. The DC offset may correspond to the drive signal. The amplifier 330 may amplify the BEMF signal to exaggerate the BEMF signal's profile. The ADC 340 may then convert the amplified signal into a digital signal. The converted digital signal may then be used to measure the frequency and/or amplitude of the BEMF signal as described in further detail below.

In one embodiment, the rectifier 310 and DC canceller 320 may be integrated together. In another embodiment, the rectifier 310 may not be needed because the DC canceller 320 may supply a DC canceling signal only in the positive semi-cycles of the input signal.

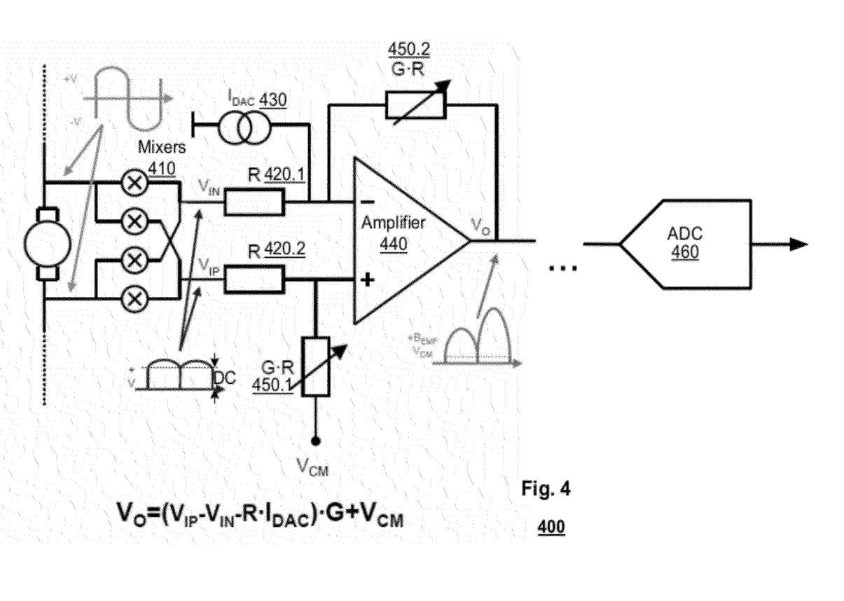

FIG. 4 is a circuit level implementation of a BEMF monitor 400 according to an embodiment of the present invention. The BEMF monitor 400 may receive input signals from a connected motor/actuator. The input signals from the motor may have both positive and negative phases. The BEMF monitor 400 may include mixers 410, resistors 420.1 and 420.2, a current source 430, an amplifier 440, gain resistors 450.1 and 450.2, and an ADC 460.

The mixers 410 may receive the input signal from the motor and may rectify the input signal to invert all negative phases. Consequently, the mixers 410 may produce an all positive phased signal. The mixers 410 may switch from semi-cycle to semi-cycle to produce an all-positive signal.

The resistors 420.1, 420.2 may be coupled to the mixers' 410 outputs. The resistors 420.1, 420.2 may mirror the resistance in the motor. The current source 430 may produce a DC canceling current to cancel the DC offset in the input signal. The DC offset may correspond to the drive signal that excited the motor into a vibratory motion. The current source's output may be coupled to the amplifier's input. The amplifier 440 may be a differential amplifier. The current source 430, for example, may be coupled to the summing node of the amplifier's 440 inverting input. The gain resistors 450.1, 450.2 may set the gain for the amplifier 440.

The ADC 460 may convert the analog input signal into a digital signal which may then be processed to measure the resonant frequency and/or the amplitude of vibration. In an embodiment, the BEMF monitor 400 may also include low pass filters following the amplifier to further narrow the signal of interest of the ADC 460. The low pass filter, for example, may be a RC low pass filter.

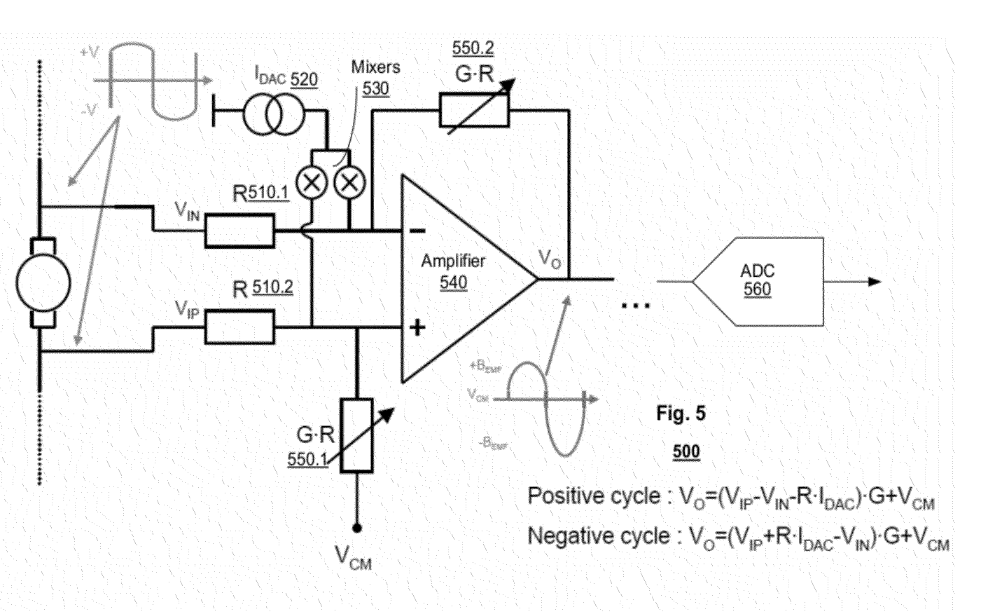

FIG. 5 is a circuit level implementation of a BEMF monitor 500 according to another embodiment of the present invention. The BEMF monitor 500 may receive input signals from a connected motor/actuator. The input signals from the motor may have both positive and negative phases. The BEMF monitor 500 may include resistors 510.1 and 510.2, a current source 520, mixers 530, an amplifier 540, gain resistors 550.1 and 550.2, and an ADC 560.

The resistors 510.1, 510.2 may mirror the resistance in the LRA. The current source 520 may produce a DC canceling current. The mixers 530 may be switches or act as switches to apply the current from the current source 520 at only the positive cycles of the input signal. Thus, in BEMF monitor 500, the DC canceling and rectifying operation may be integrated.

The mixer's 530 output may be coupled to amplifier 540's input. The mixers 530 may couple the current source 520 to a different summing node of the amplifier 540 from semi-cycle to semi-cycle. The amplifier 540 may be a differential amplifier. The gain resistors 550.1, 550.2 may set the gain for the amplifier 540.

The ADC 560 may convert the analog input signal into a digital signal which may then be processed to measure the resonant frequency and/or the amplitude of vibration. In an embodiment, the BEMF monitor 500 may also include low pass filters following the amplifier to further narrow the signal of interest of the ADC 560. The low pass filter, for example, may be a RC low pass filter.

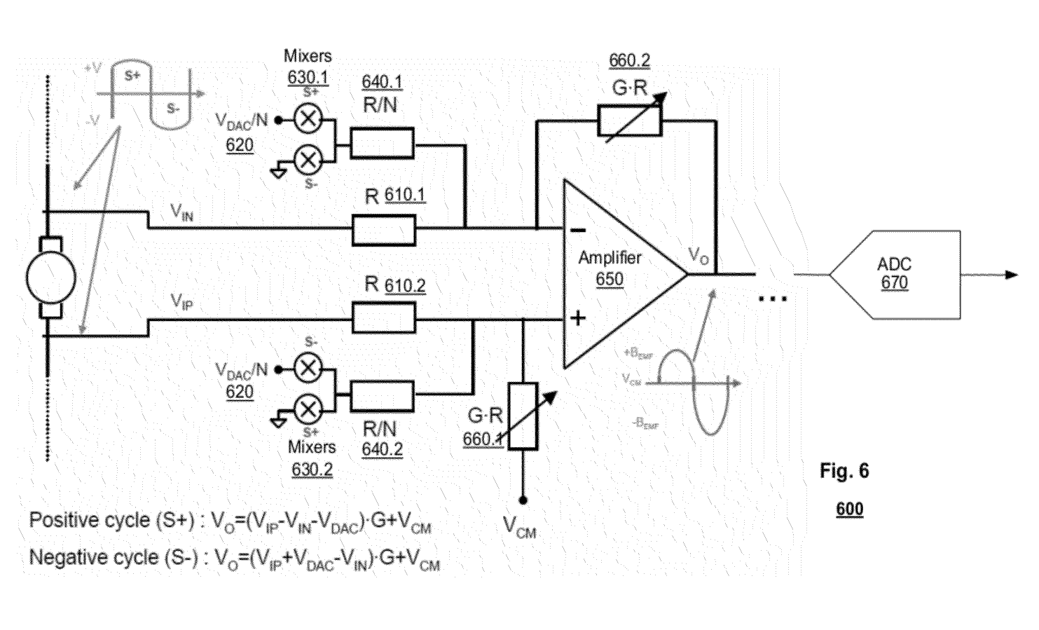

FIG. 6 is a circuit level implementation of a BEMF monitor 600 according to another embodiment of the present invention. BEMF monitor 600 may use a voltage source as the DC canceling source. The BEMF monitor 600 may receive input signals from a connected motor/actuator. The input signals from the motor may have both positive and negative phases. The BEMF monitor 600 may include resistors 610.1 and 610.2, a voltage source 620, two pair of mixers 630.1 and 630.2, matching resistors 640.1 and 640.2, an amplifier 650, gain resistors 660.1 and 660.2, and an ADC 670.

The resistors 610.1, 610.2 may mirror the resistance in the LRA. The voltage source V_{DAC} 620 may produce a DC canceling voltage. In some implementations such as a string DAC, a voltage source may be preferable to a current source to cancel the DC offset. The mixers 630.1, 630.2 may be or may act as switches to apply the voltage from V_{DAC} 620 at only the positive cycles of the input signal. Thus, in BEMF monitor 600, the DC canceling and rectifying operation may be integrated. The matching resistors 640.1, 640.2 may match the resistance of the voltage source 620.

The amplifier 650 may be a differential amplifier. The mixers 630.1, 630.2 couple the V_{DAC} 620 to a different summing node of the amplifier 650 from semi-cycle to semi-cycle. The gain resistors 660.1, 660.2 may set the gain for the amplifier 650.

The ADC 670 may convert the analog input signal into a digital signal which may then be processed to measure the resonant frequency and/or the amplitude of vibration. In an embodiment, the BEMF monitor 600 may also include low pass filters following the amplifier to further narrow the signal of interest of the ADC 670. The low pass filter, for example, may be a RC low pass filter.

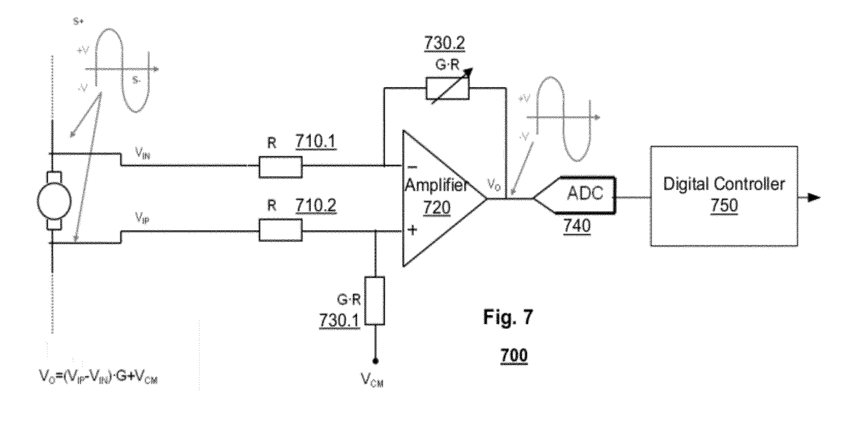

In an embodiment of the present invention, the BEMF monitor may be implemented primarily using digital circuitry. A digital implementation may reduce the analog circuitry components and, consequently, may reduce the BEMF monitor size. Also, a primarily digital implementation may be reconfigurable and programmable. FIG. 7 is a circuit level implementation of a BEMF monitor 700 that monitors the BEMF primarily using digital circuitry according to an embodiment of the present invention.

The BEMF monitor 700 may receive input signals from a connected motor/actuator. The input signals from the motor may have both positive and negative phases. The BEMF monitor 700 may include resistors 710.1 and 710.2, an amplifier 720, gain resistors 730.1 and 730.2, an ADC 740, and a digital controller 750.

The resistors 710.1, 710.2 may mirror the resistance in the LRA. The resistors' 710.1, 710.2 output may be coupled to the amplifier's 720 input. The gain resistors 730.1, 730.2 may set the gain for the amplifier 720. The ADC 740 may convert the analog signal into a digital signal which will then be processed to establish the resonant frequency and/or the amplitude of vibration. The ADC 740 may be a high resolution ADC to measure accurately the BEMF component in a wide dynamic range with the DC offset still remaining in the analog input signal. The digital controller 750 may digitally remove the DC component of digitized signal.

In the primarily digital implementation of the BEMF monitor 700, the DC component may be removed from the digitized signal. After removing the DC component, the BEMF signal may be isolated. The ADC 740 in this embodiment may sample both positive and negative phases of the input signal. Accordingly, the amplifier 720 in the embodiment may have a variety of different configurations such as an instrumentation amplifier. Furthermore, the frequency and amplitude measuring techniques described below may be applicable to both analog and digital DC component removing implementations.

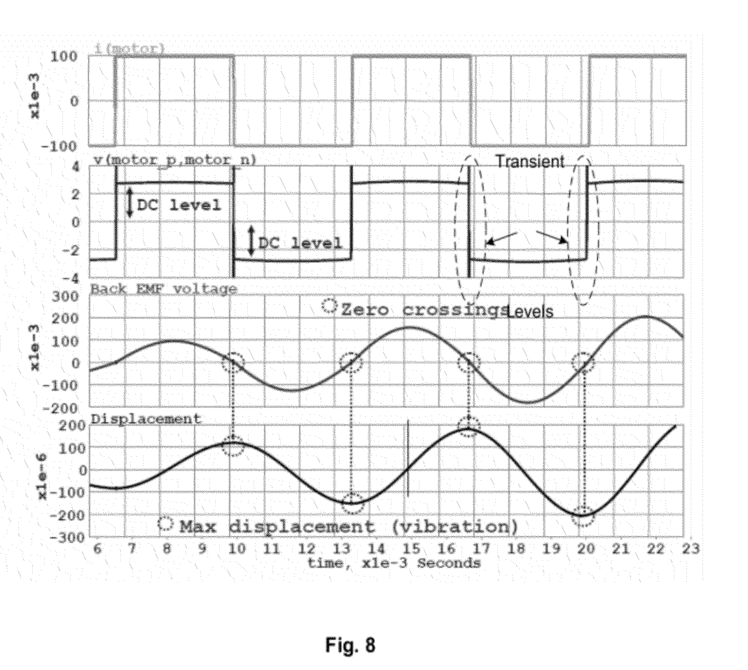

FIG. 8 is a timing graph simulating a drive signal, a voltage signal seen across a motor, a BEMF signal, and the motor's displacement. The first (top) graph shows a drive signal. The drive signal may be a current signal, and the drive signal may be a rectangular wave signal such as a square wave shown.

The second graph shows the voltage signal generated across the terminals of the motor. The voltage signal is generated by the current flowing through the resistance of the motor which produces a DC change in the voltage level. The voltage signal may also include a transient level, which is generated by the sudden change in the current signal applied to the inductance element of the motor and is shown as the spikes in voltages on the second graph. The voltage signal may also incorporate the BEMF signal superimposed on the DC level.

The third graph shows the BEMF signal with the DC and transient levels removed. When driving at the mechanical resonant frequency of the motor, the zero crossings of the BEMF signal should optimally correspond to the rising and falling edge of the drive signal. The fourth graph shows the motor's displacement (vibration). The maximum displacement should optimally correspond with the zero crossings of the BEMF signal and the rising/falling edges of the drive signal.

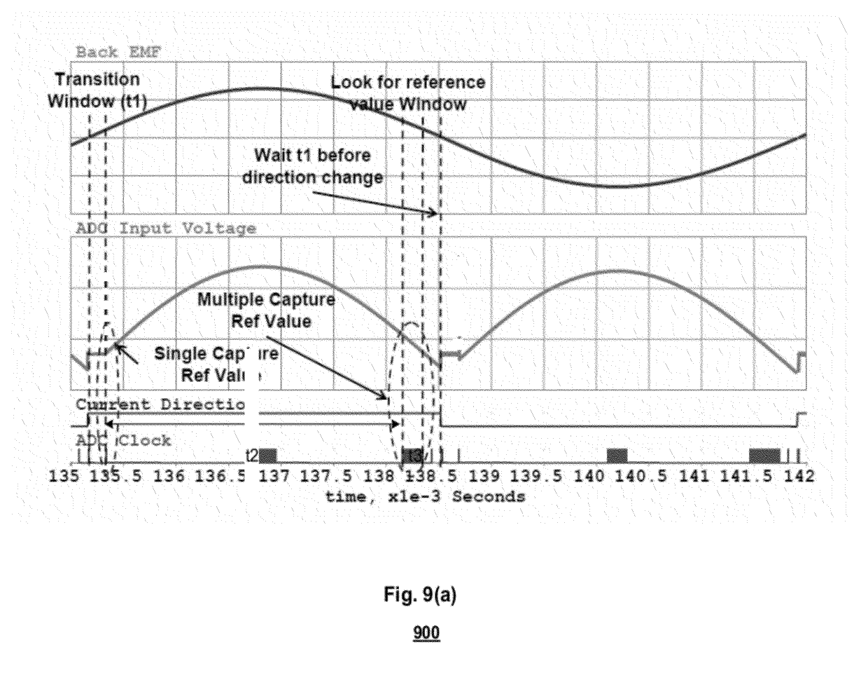

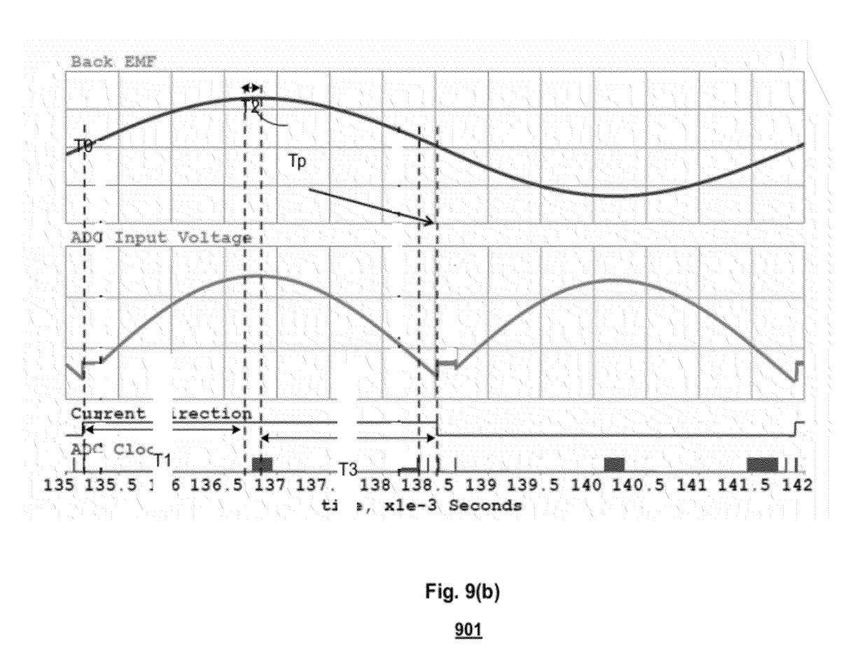

In an embodiment of the present invention, BEMF frequency may be calculated by determining the zero crossings of the BEMF signal. FIG. 9(a) is a timing graph showing a method to measure the BEMF signal's zero crossing according to an embodiment of the present invention. The top graph shows a BEMF signal captured from a vibrating motor, and the bottom graph shows an input voltage into the ADC of a BEMF monitor.

The BEMF signal may be measured in transition window t1, which starts after a change in current direction of the drive signal. Transition window t1, may contain a spike in the ADC input voltage, which represents the transient level caused by the current change. A first reference point for determining the frequency of the BEMF signal may be measured at the end of transition window t1. At this point in time, the transient level has decayed sufficiently to begin reference point measurement.

During a time period t2, the ADC may continue to sample the BEMF signal or may suspend sampling for a time less than half of the resonant period. After time period t2, the BEMF signal may be monitored again to find a second reference point. The second reference point is the voltage which equates (within a tolerance) to the voltage level of the first reference point. The frequency of the BEMF signal may then be derived using the first and second reference points. The resonant period may be slightly above the time lapse between the first and second measured reference points. Further, the BEMF measurements may be performed iteratively to provide continuous adjustment for drive signal output.

The transition windows may be synchronized with a single capture reference value or multiple capture reference values, which are controlled by the ADC clock. Multiple reference values may provide a more accurate measurement while also may use more resources as compared to the single capture reference.

In one embodiment, the reference values may correspond to the BEMF signal's peak value. The estimated transition windows for peak value measurements may be preprogrammed using prior knowledge of the system or may be a coarse estimate. The coarse estimate may be updated and/or reconfigured.

In another embodiment of the present invention, BEMF frequency may also be calculated by determining the peak voltage of the BEMF signal. FIG. 9(b) is a timing graph showing a method to determine the BEMF signal's frequency using peak voltage measurements according to an embodiment of the present invention. The top graph shows a BEMF signal captured from a vibrating motor, and the bottom graph shows an input voltage into the ADC of a BEMF monitor.

Following a change in current direction at time T0, the ADC may continue or suspend sampling for a time period T1, which is less than a quarter of the resonant period approximately. After a time period T1, the BEMF signal may be monitored for time period T2, a sampling period, to find a first reference point. The first reference point may be the peak voltage of the BEMF signal, designated by peak time Tp where Tp is the time from the beginning of the sampling period to when the first reference point of the peak voltage is measured.

The frequency of the BEMF signal may then be derived. The resonant period may be approximately four times the time period between the change in current direction (T0) and the first measured reference point at the peak time (T1+Tp). After detecting the first reference point, a change in the current direction is then applied after a time T3 which is approximately equal to the sum of T1 and Tp. The BEMF measurements may be performed iteratively to provide continuous adjustment for drive signal output.

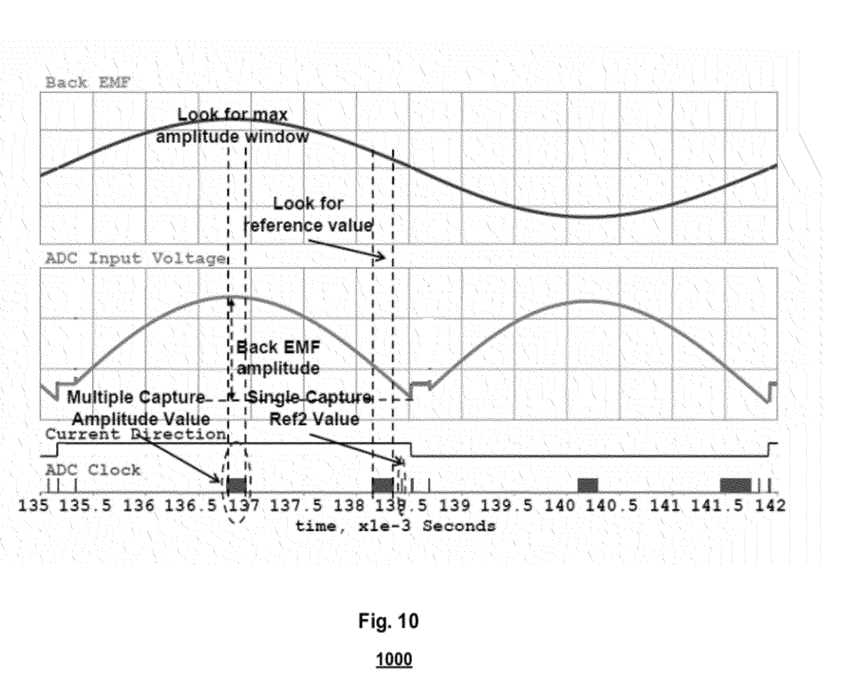

In an embodiment of the present invention, a BEMF signal magnitude may be measured by monitoring the maximum amplitude of the BEMF signal. FIG. 10 is a timing graph to determine the BEMF signal's amplitude using peak voltage measurements according to an embodiment of the present invention. The top graph shows a BEMF signal captured from a vibrating motor, and the bottom graph shows an input voltage into the ADC of a BEMF monitor.

Maximum amplitude of the BEMF signal usually will occur at the midpoint of the current pulse. The ADC clock may set reference values to determine the window for when the BEMF signal will peak. Based on the reference values, a window for max amplitude may be set by the ADC. The peak value measured in this window may correspond to the maximum amplitude.

According to an embodiment of the present invention, a dual mode driver may be provided in a haptic generation system with a continuous drive signal. The two modes may be linear drive mode and switched drive mode. The switched drive mode may have lower power consumption but may generate higher electrical noise than the linear drive mode. Also, the dual mode driver may be in linear drive mode when measuring the BEMF signal.

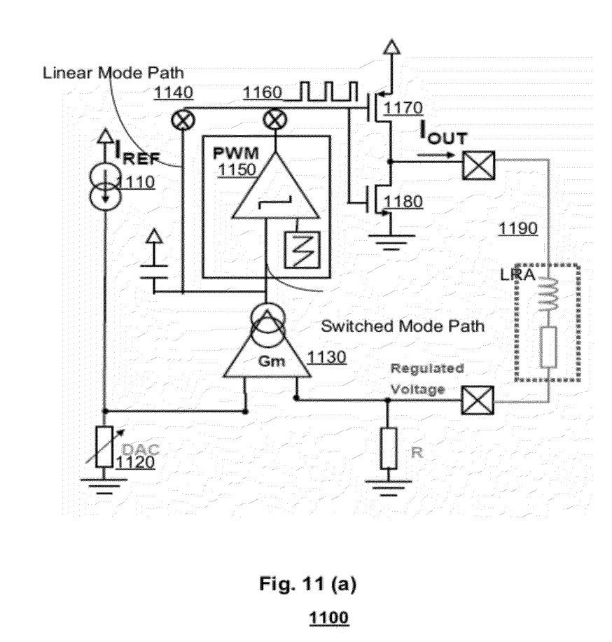

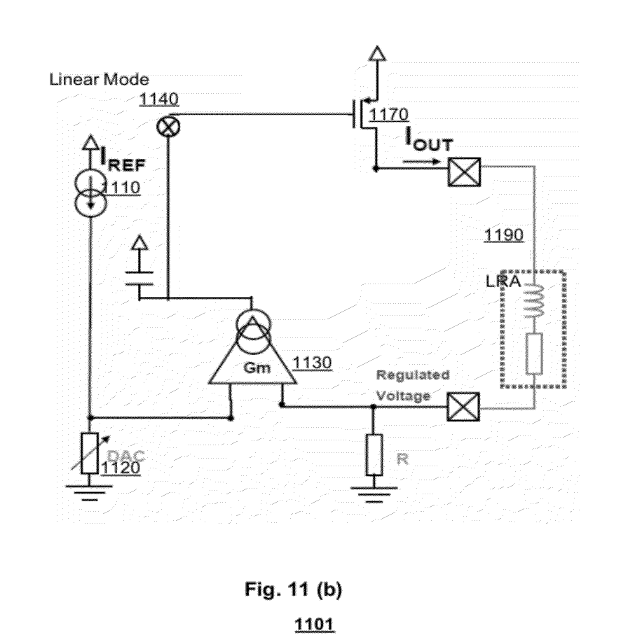

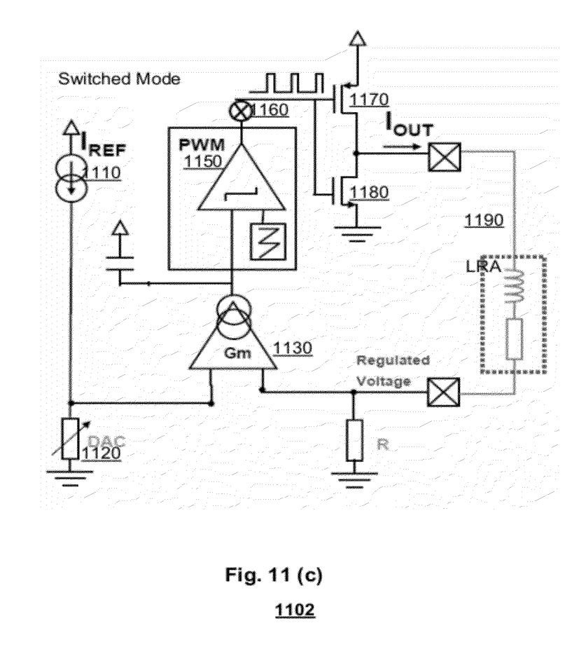

FIG. 11(a) is a simplified diagram of a dual mode driver 1100 according to an embodiment of the present invention. The dual mode driver 1100 may include a current source 1110, a DAC 1120, an op-amp 1130, a switch 1140, a pulse width modulator 1150, a switch 1160, and a pair of drive transistors 1170 and 1180. The dual mode driver 1100 may be coupled to a LRA/motor 1190. The LRA 1190 may be represented by electrical components of a resistor element and inductor element as described above in reference to FIG. 1(b).

The op-amp 1130 may control the magnitude of the drive signal in either mode. The op-amp 1130 may amplify a regulated voltage according to the current source I_{REF} 1110. The drive transistors may be complimentary transistors (one is a p type and the other is an n type transistor). The transistors selectively switch on/off at the same time according to the switched mode signals that are coupled to the transistors' gate. The output of the transistors may be coupled to generate the current drive signal I_{OUT}. The LRA 1190 may receive the current drive signal I_{OUT} and generate the reference voltage which is used to regulate the motor current.

The switches 1140 and 1160 may control the mode of the dual mode driver 1100. In linear mode, switch 1140 may be closed, and switch 1160 may be open. In switched mode, switch 1140 may be open, and switch 1160 may be closed.

FIG. 11(b) is a simplified diagram of the dual mode driver of FIG. 11(a) in linear mode 1101 according to an embodiment of the present invention. The switch 1140 may be closed to provide the linear mode path, and switch 1160 (not shown) may be open. The dual mode driver in linear mode 1101 may include the current source 1110, the DAC 1120, the op-amp 1130, the switch 1140, the drive transistor 1170. The op-amp 1130 may control the magnitude of the drive signal in either mode. The op-amp 1130 may amplify a regulated voltage according to the current source I_{REF} 1110. The output of the transistor 1170 may generate the current drive signal I_{OUT}. The LRA 1190 may receive the current drive signal I_{OUT} and generate the reference voltage which is used to regulate the motor current. Further, a sensing resistor R may sense the voltage across the LRA 1190 to control the drive output.

FIG. 11(c) is a simplified diagram of the dual mode driver of FIG. 11(a) in switched mode 1102 according to an embodiment of the present invention. The switch 1160 may be closed to provide the mode path, and switch 11400 (not shown) may be open. The dual mode driver in switched mode 1102 may include a pulse width modulator 1150, a switch 1160, and a pair of drive transistors 1170 and 1180. The op-amp 1130 may control the magnitude of the drive signal in either mode. The op-amp 1130 may amplify a regulated voltage according to the current source I_{REF} 1110. The pulse width modulator 1150 may include a comparator that receives the op-amp 1130 output as one input, and a saw waveform as the other input. The pulse width modulator 1150 may output a pulsed mode signal. The drive transistors may be complimentary transistors (one is a p type and the other is an n type transistor). The transistors selectively switch on/off at the same time according to the switched mode signals that are coupled to the transistors' gate. The output of the transistors may be coupled to generate the current drive signal I_{OUT}. The LRA 1190 may receive the current drive signal I_{OUT} and generate the reference voltage which is used to regulate the motor current. Further, a sensing resistor R may sense the voltage across the LRA 1190 to control the drive output.

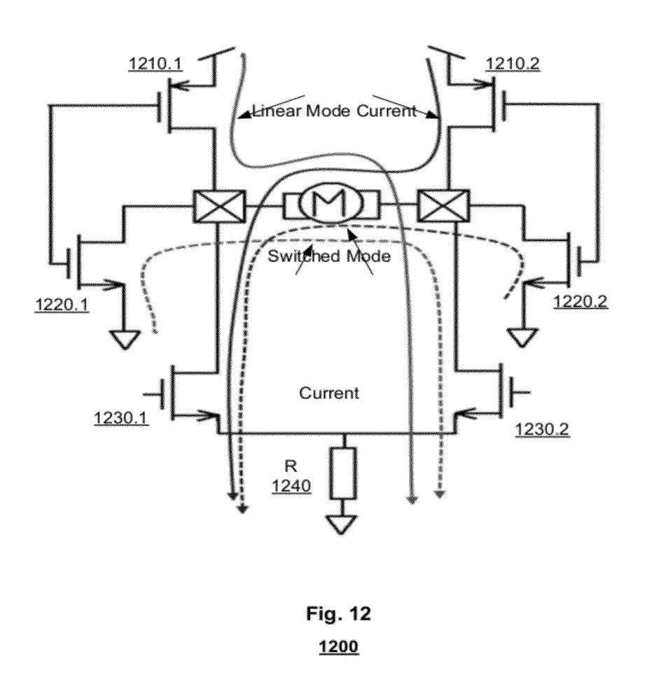

Bi-directional current may be achieved by placing the drive transistors in an H-bridge configuration. FIG. 12 is a simplified diagram of a system 1200 with drive transistors in an H-bridge configuration and shows the direction of current flow for both linear and switched mode configurations. The solid lines represent linear mode and the dotted lines represent switched mode. The system 1200 may include a first set of drive transistors 1210.1, 1210.2, a second set of drive transistors 1220.1, 1220.2, a third set of drive transistors 1230.1, 1230.2, and a sensing resistor 1240.

The first set of transistors 1210.1, 1210.2 may be pmos type transistors. The second set of transistors 1220.1, 1220.2 may be nmos type transistors. The third set of transistors 1230.1, 1230.2 may be nmos type transistors.

In linear mode during a positive current pulse, current may flow through transistor 1210.1 and 1230.2, and all other transistors may be off. In linear mode during the negative current pulse, current may flow through transistor 1210.2 and 1230.1, and all other transistors may be off. Voltage may be sensed at the sensing resistor 1240. According to the sensed voltage, driving voltages at the gates of the transistors may be adjusted to regulate the motor's current.

In switched mode during a positive current pulse, current may flow through transistor 1210.1 and 1230.2 during the first part of the cycle. The current flow may charge the inductor component in the motor.

In switched mode during the positive current pulse, transistors 1210.1 may turn off and transistor 1220.1 may turn on, the charge built in the inductor during the first part of the cycle may keep the current flowing through 1220.1 and 1230.2 as shown by the current flow diagram. In switched mode during a negative current pulse, current may flow through transistor 1210.2 and 1230.1 during the first part of the cycle. The current flow may flow charge the inductor component in the motor. Further in switched mode during the negative current pulse, transistors 1210.2 may turn off and transistor 1220.2 may turn on, the charge built in the inductor during the first part of the cycle may keep the current flowing through 1220.2 and 1230.1 as shown by the current flow diagram. Voltage may be sensed at the sensing resistor 1240. According to the sensed voltage, driving voltages at the gates of the transistors may be adjusted to regulate the motor's current. For example, the duty cycle of the gate voltages may be adjusted depending on the sensed voltage level.

The embodiments of the present invention described above show a current drive signal and voltage sensed signal from which the BEMF signal is measured. In another embodiment of the present invention, a voltage drive signal may be utilized and a current signal may be monitored to determined BEMF signal. According to the BEMF signal properties, the voltage drive signal's frequency and/or amplitude may be adjusted. A voltage drive signal may reduce the current flowing through the motor.

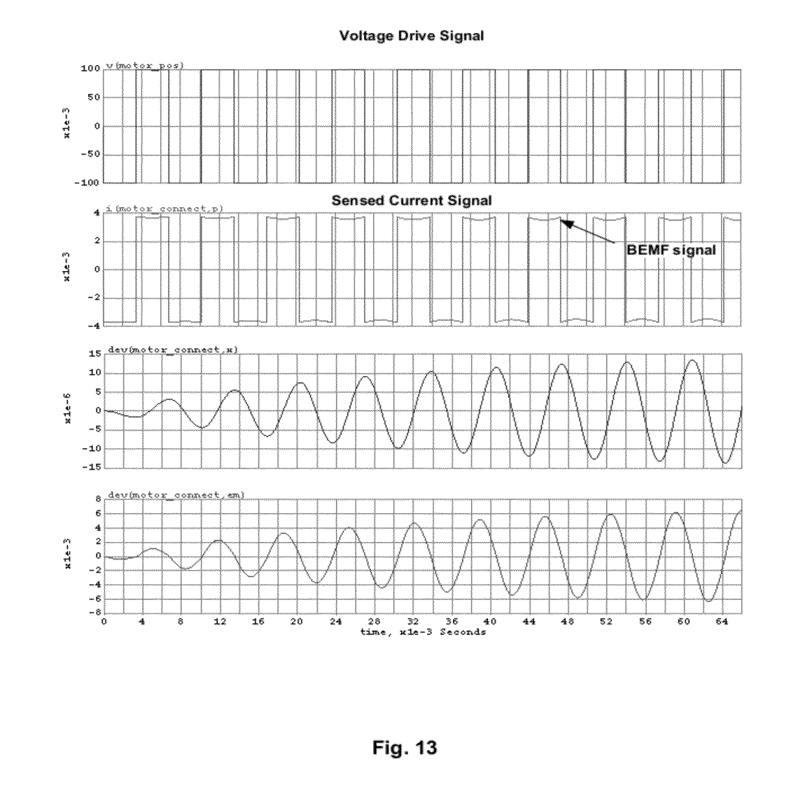

FIG. 13 is a timing graph simulating a drive signal, a sensed current signal in the motor, a BEMF signal, and the motor's displacement. The first (top) graph shows a drive signal. The drive signal may be a voltage signal, and the drive signal may be a rectangular wave signal such as a square wave shown.

The second graph shows the current signal generated in the motor. The BEMF signal may be superimposed on the current signal. In the second graph, the BEMF is illustrated as a “trough” on top of the sensed current signal. Thus, the BEMF may reduce the current supplied to the motor.

The third graph shows the motor's displacement (vibration). The fourth graph shows the BEMF signal with the DC current removed. The maximum displacement should optimally correspond with the zero crossings of the BEMF and the rising/falling edges of the drive signal.

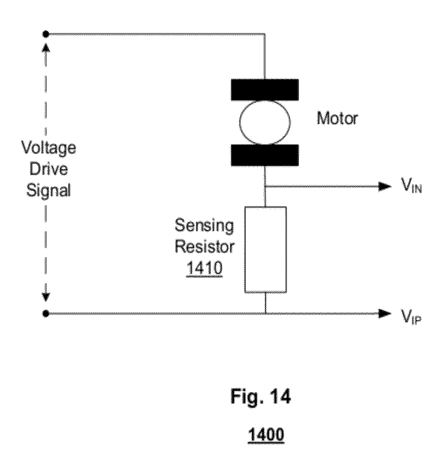

To measure the current signal, the sensed current may be supplied to a sensing resistor in the BEMF monitor. FIG. 14 is a simplified block diagram of a sensing resistor 1410 coupled to a motor with a voltage drive signal according to an embodiment of the present invention. The voltage across the sensing resistor may then be processed similar to the voltage input signal as described herein with references to FIGS. 3-7. Furthermore, the same methods of detecting the resonance frequency and vibration amplitude may apply to voltage drive/sensed current embodiments described herein with reference to current drive/sensed voltage embodiments.

Moreover, embodiments of the present invention may be practiced using different drive profiles. While square waves may provide the most energy to the motor because squares waves have the greatest area under the curve, square waves also may include harmonics that are in the audible range. The harmonics, consequently, may generate unwanted buzzing or echoing sounds during the haptic effect. Thus, there may be a trade-off between effect intensity and harmonic side effects.

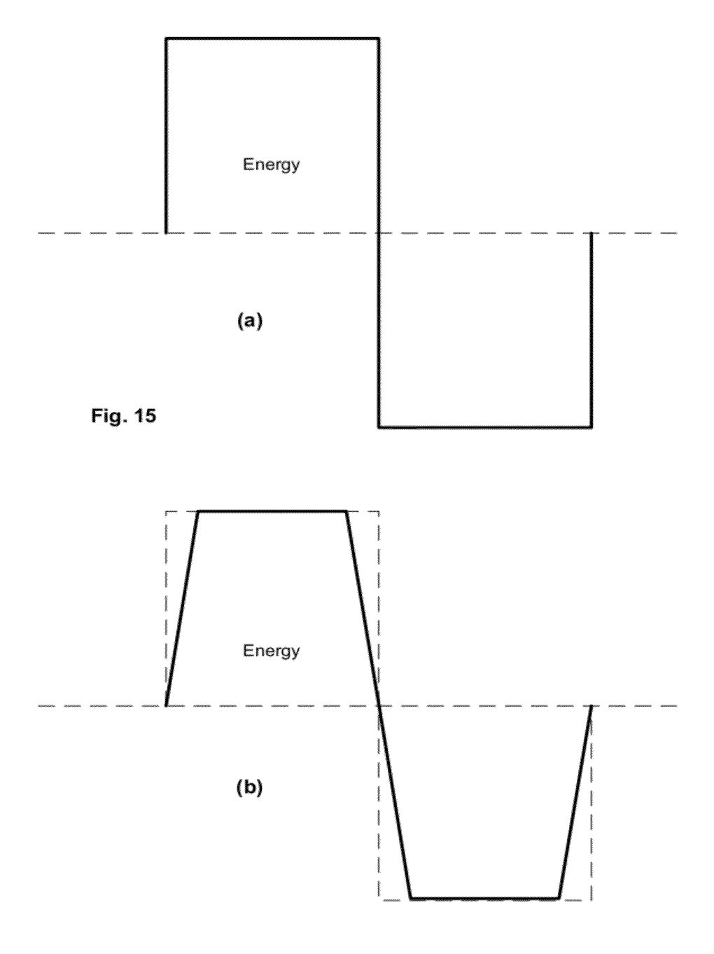

One alternative to a square wave drive signal may be a rhombic shaped drive signal. FIG. 15 illustrates a square wave drive signal and a rhombic shaped drive signal. The square wave drive signal, as illustrated in FIG. 15(a) may provide the most intense drive signal; however, the square wave drive signal may produce undesirable audible ranged harmonics. Additionally, the square wave is not the most energy efficient driving signal as the energy in the harmonics does not turn into motion. In addition, the square wave drive signal may not be perfectly “square” but may also be “rectangular” in an embodiment of the present invention.

The rhombic shaped drive signal, as illustrated in FIG. 15(b), may provide less energy to the motor than a similar magnitude square wave, the but the slope of the signal may not produce audible ranged harmonics and be more efficient in the sense that most energy lies in the natural resonance frequency. The drive signal may also be shaped as a triangular wave signal in an embodiment of the present invention. For a rhombic or other non-rectangular shaped drive signal, the reference point for change in current may be the top of the ramp when the current reaches its highest value.

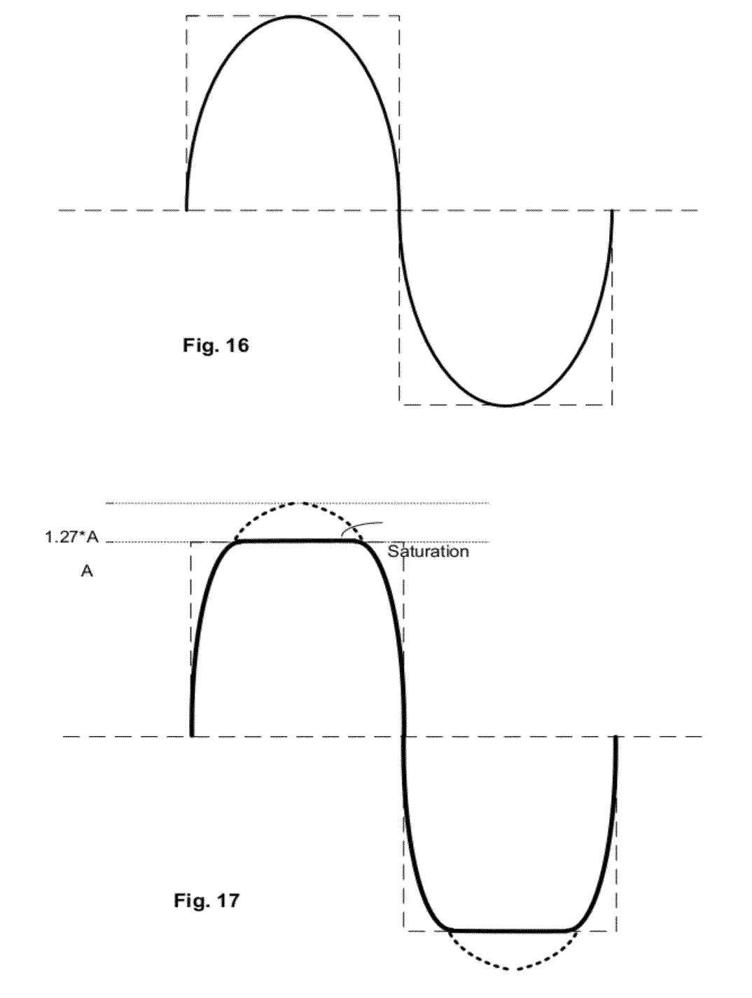

In another embodiment of the present invention, a sinusoidal drive signal may be provided to drive the motor. FIG. 16 illustrates a sinusoidal drive signal. The sinusoidal drive signal may provide less energy to the motor than a similar magnitude square wave, but the sinusoidal signal may also not produce audible ranged harmonics and may be the most efficient option because 100% of the energy is applied at the resonant frequency. Alternatively a multi level symmetric drive signal that generates a pseudo sine wave may be provided as a trade-off between harmonic performance (audible noise) and implementation complexity.

In one embodiment, a saturated sinusoidal signal may be generated to provide greater energy efficiency. For example, instead of a sinusoidal signal with peaks at +1 and −1, a sinusoidal signal with peaks at +2 and −2 that is saturated between +1 and −1 may be generated. Thus, the saturated sinusoidal signal may be more energy efficient while reducing audible range harmonics.

In another embodiment, a higher magnitude sinusoidal signal may be provided to compensate for any loss in energy. FIG. 17 illustrates a sinusoidal drive signal. A sinusoidal drive signal with magnitude 1.27*A may apply approximately the same energy in the resonant frequency than a square wave drive signal with magnitude A while being more efficient. The sinusoidal drive signal may become saturated at magnitude A.

The use of sinusoidal drive signals may affect the time when the BEMF can be measured. The voltage seen at the motor may be characterized as:

$$V = Ri + L \frac{d i}{d t} + \frac{d λ}{d t} ,$$

where R is the resistance component in the motor, i is the current, L is the inductor component in the motor,

$$\frac{d i}{d t}$$

is the rate of change of the current, and

$$\frac{d λ}{d \text{?}}$$

$$\text{?} \text{indicates text missing or illegible when filed}$$

is the BEMF. Stated differently, the voltage at the motor is the sum of the voltages seen at the resistor and inductor components, and the BEMF. Thus, the BEMF may be characterized as:

$$\frac{d λ}{d t} = V - Ri - L \frac{d i}{d t} .$$

BEMF may be measured when the rate of change of the current is zero because of the inductor component. The drive current and sensed voltage peaks may occur when the change in current is zero because of the inductor component; hence, BEMF may be measured at this time. Therefore, BEMF voltage may be simplified to:

$$\frac{d λ}{d t} = V - Ri$$

If the drive signal is not at the resonance frequency, a frequency error may be detected between the drive signal and BEMF signal. In this situation, the peaks of the drive current and sensed voltage may not occur at the same time. The frequency error may be measured, and the drive signal may be adjusted until the drive peaks of the drive current and sensed voltage are synchronized.

The sinusoidal drive signal may be a current drive signal or may be a voltage drive signal according to embodiments of the present invention. Also, the present invention may sense either voltage across the LRA or current through the LRA to detect the BEMF generated respectively according to the drive signal properties. As the equation above indicates, the BEMF voltage may be the difference of the sensed voltage and the voltage seen across the resistor component of the LRA. The detected BEMF current, accordingly, may be the difference between the sensed current and the current at the resistor component of the LRA.

Adjustment of the sinusoidal drive signal may be executed in two stages. First, the drive frequency may be adjusted by aligning the peak current and peak voltage of the sensed signal. This may correspond to the motor vibrating at its resonance frequency. Second, the amplitude of the drive signal may be adjusted according to the desired vibration strength because the amplitude of the peak voltage/current may be equal to the BEMF, which is proportional to the vibration strength.

Adjustment may be accomplished by closed loop control system provided within the BEMF monitor. Various types of control loops may be employed, including proportional loop controls (“P-Loops,”), Proportional Integrative Loop controls (PI-Loop) or a full Proportional Derivative Integrative control (PDI-Loop). A P-Loop is likely to be the simplest one to implement and responds faster than PI Loops and without the instability that PDI Loops may involve. The P-Loop may be configured to reduce its proportional gain depending on a difference between a desired BEMF amplitude (vibration) and the required BEMF amplitude. When the vibration is within a programmable limit, the P-Loop gain may be set to one, otherwise may be set to a value selected from a locally-stored stored register map. The gain values may be programmable and may be set as a percentage of the maximum BEMF.

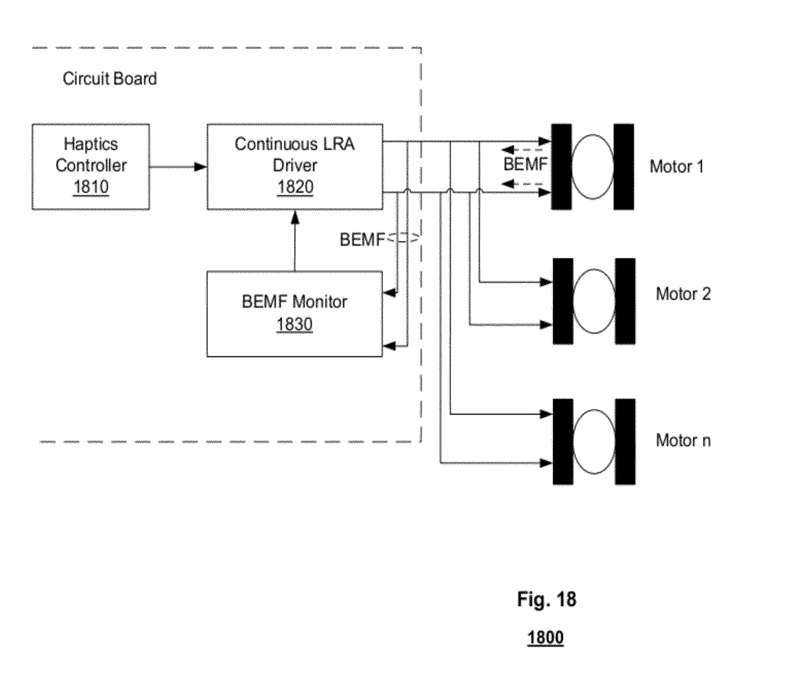

In an embodiment of the present invention, multiple LRAs may be arranged in parallel to generate multiple haptic effects. Thus, the user may feel one type of vibration at one part of the device and another type of vibration at another part of the device. FIG. 18 is a simplified block diagram of a multiple LRA system 1800 according to an embodiment of the present invention.

The system 1800 may include a haptics controller 1810, a continuous LRA driver 1820, and a BEMF monitor 1830. The continuous LRA driver 1820 may be coupled to a plurality of motors/LRAs 1-n via signal lines from a common output. The signal lines may be pairs of electrical lines. The BEMF monitor 130 may also be coupled to the signal line.

According to a haptic effect request, the haptics controller 1810 may generate a corresponding control signal to output to the continuous LRA driver 120. The haptic effect request may include a request for multiple haptic effects. The continuous LRA driver 1820 may receive the control signal from the haptic controller 1810 and may generate a drive signal accordingly. The drive signal may be continuous. The continuous LRA driver 1820 may output the generated drive signal to the plurality of motors 1-n where the drive signal may cause each motor to vibrate and, thus, generating the desired haptic effect(s). The drive signal may be outputted to an output pin by the continuous LRA driver 120, and the motors 1-n may also be coupled to the output pin.

Each motor may include a coil motor with a spring loaded mass. The motor may include a permanent magnet. The motor may cause the spring loaded mass to vibrate to generate the haptic effect. The motor may also include magnetic coils to generate the motion. Moreover, the vibration by the motor may induce a BEMF signal to be produced in the electrical signal lines coupled to the motor. The BEMF signal's frequency may correspond to the mechanical system's resonant frequency, and the BEMF signal's amplitude may correspond to the mechanical system's vibration magnitude.

The BEMF monitor 1830 may capture the BEMF signal from the electrical signal lines that are used to apply the drive signal to the motor. The BEMF monitor 1830 may be coupled to the same output pin to where the continuous LRA driver 1820 outputs the drive signal and to where the motor is coupled. The BEMF signal may be the sum of all the BEMF signals. Since the drive signal may be a continuous signal, the BEMF monitor 130 may separate the BEMF signal from the drive signal. After separating the BEMF signal, the BEMF monitor 1830 may measure the BEMF signal's frequency and/or amplitude. The BEMF monitor 1830, according to the measurement values, may transmit an adjustment signal to the LRA driver 1820. The LRA driver 1820 may then adjust the drive signal's frequency and/or amplitude in order to produce an optimum drive signal.

The haptics controller 1810, continuous LRA driver 1820, and BEMF monitor 1830 may be fabricated on separate integrated circuits or may be combined in a common integrated circuit. For example, the continuous LRA driver 1820 and the BEMF monitor 1830 may be fabricated on a single integrated circuit. The integrated circuit(s) may be placed on a circuit board, for example a printed circuit board (PCB).

In an embodiment of the present invention, the LRA system may be a multi-functional actuator. The multi-functional actuator may include a vibration element as described in the above-mentioned embodiments and a speaker element for audio generation. The generated audio may be synchronized with the vibration generation to provide a user multi-sensory feedback system.

Other enhancements may be provided to provide robust performance in non-ideal operation environments where sources of interference may be present. Interference may arise from several different sources. For example, transient spikes on power supplies potentially can couple through to the output driver and could introduce an error in the magnitude of the desired output drive signal. A small change in the output drive signal could cause a larger change in the induced BEMF signal. This could lead to a large error in the feedback and significantly reduce the performance of the driver leading to a poor and inconsistent haptic effect for an end user.

As another example, mechanical shock induced in the haptic system, for example if a user dropped a handset in which the system resides onto a hard surface, can create interference. Such shocks could induce an undesired BEMF signal which could in turn cause the driver to compensate and drive the actuator at a time when it was not required to. Or, a similar mechanical shock induced during a haptic effect could lead to a distorted BEMF signal which could in turn lead to a distorted haptic effect. Embodiments of the present invention may include interference rejection features to support robust and consistent performance, even in the presence of such interferers.

Power supply rejection may be accomplished in a variety of ways. In a first embodiment, the output driver may be designed with good power supply rejection. A variety of techniques can be employed to achieve power supply rejection, many of which ensure constant Vgs and Vds within driver transistors, so the current generated by the driver is independent on any frequency interference. Another technique is to decouple the driver output, which can be done using a buffer. This increases the output driver bandwidth, so the driver control loop can react and correct the current value faster making it independent from power supply interferences.

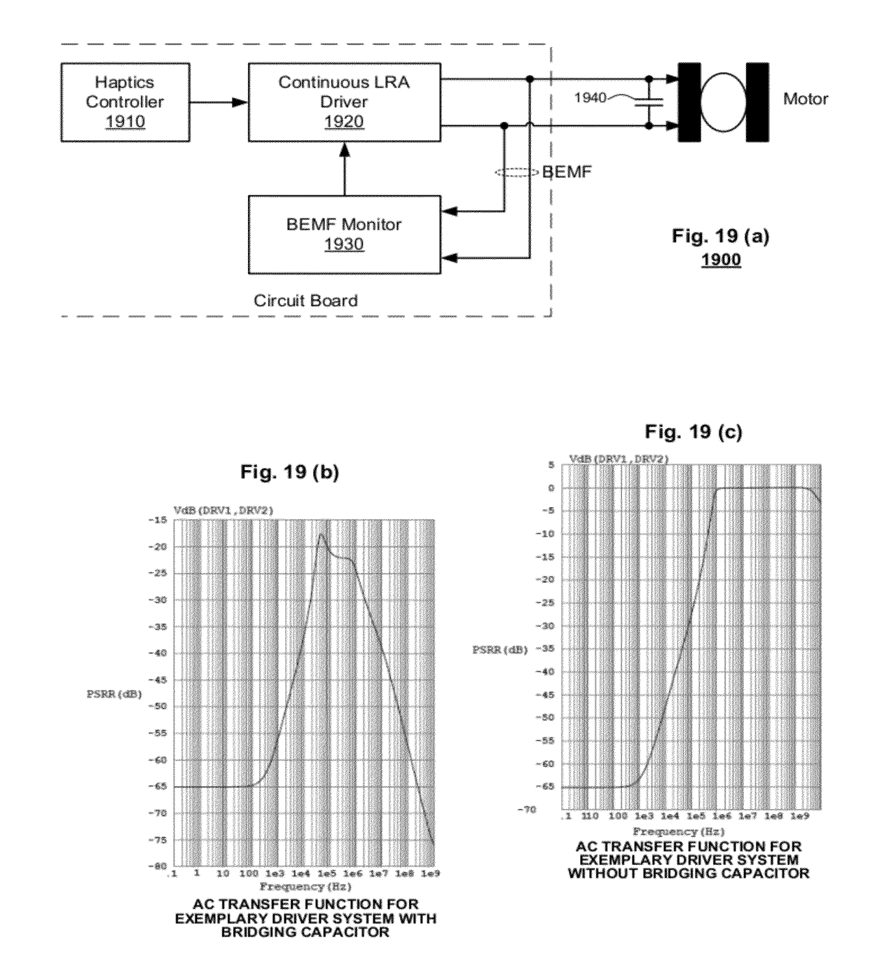

Yet another embodiment is illustrated in FIG. 19 (a). In this embodiment, a haptics system 1900 may include a haptic controller 1910, LRA driver 1920 and BEMF monitor 1930 as in prior embodiments and also may include a capacitor 1940 bridging terminals of the actuator motor. The added capacitor 1940 of this embodiment may add a pole in the overall transfer function which may help to increase power supply rejection. The capacitor 1940 may be sized appropriately in conjunction with impedance of the actuator to place the pole in desired locations in frequency distribution to tailor power supply rejection to individual needs. FIG. 19 (b) illustrates a frequency plot of an AC transfer function for an exemplary driver system constructed in accordance with FIG. 19 (a). For comparative purposes, FIG. 19 (c) illustrates a second plot of an AC transfer function for the same driver system but without the bridging capacitor.

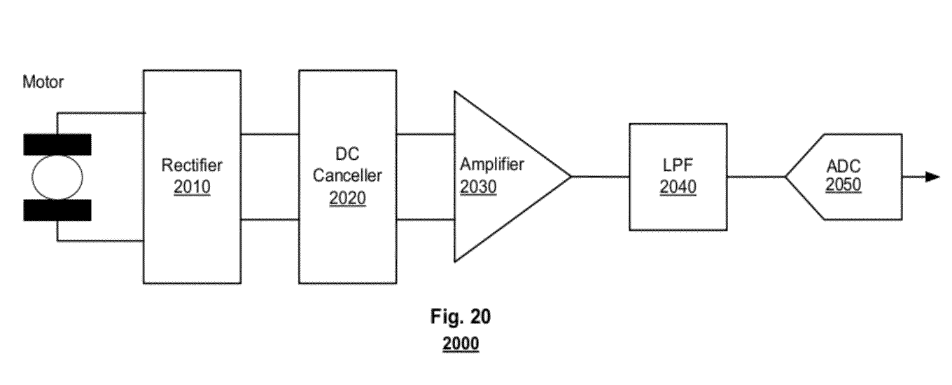

FIG. 20 illustrates another embodiment for power supply rejection. In this embodiment, a BEMF monitor 2000 may include a rectifier 2010, a DC canceller 2020, an amplifier 2030, a low pass filter 2040, and an ADC 2050. This embodiment operates in a manner similar to the embodiment of FIG. 3 but the low pass filter 2040 provides protection against transient signals from propagating to the ADC 2050. Characteristics of the low pass filter 2040 may be tailor to suit individual design needs.

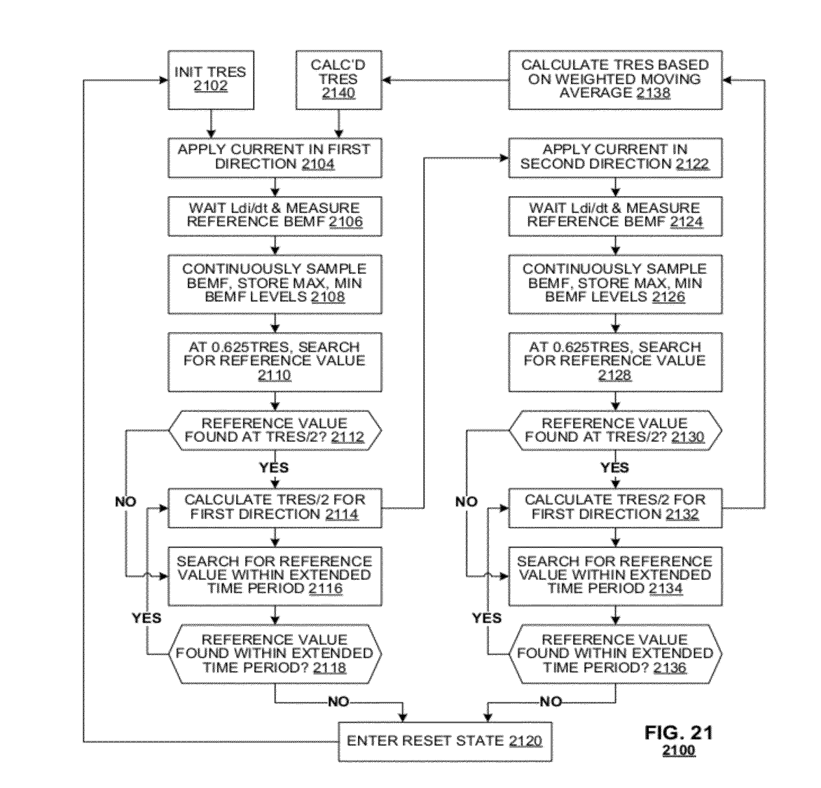

FIG. 21 illustrates a method 2100 of calculating a resonant frequency of a haptic actuator according to an embodiment of the present invention. The method may begin in block 2102 where an initial estimate of a resonant period Tres is defined. The estimated resonant period Tres may be input to an integrated circuit or stored in a register within the integrated circuit. The method 2100 may apply a driving current to the actuator a first direction (box 2104). Thereafter, the method 2100 may wait for a predetermined period of time and measure a BEMF level, taking the measured level to be a reference BEMF value (box 2106). The method 2100 may sample the BEMF value continuously thereafter and store maximum and minimum BEMF values until a predetermined amount of time has elapsed (box 2108). In an embodiment, the predetermined amount of time may be set to ⅝ths of the estimate of Tres. After the predetermined amount of time has elapsed, the method 2100 may continue to sample the BEMF values and search until time ½ Tres to detect a BEMF sample value that matches the reference BEMF value (boxes 2110, 2112). If a BEMF sample value is identified that matches the reference value, then at box 2114 the method 2100 may estimate a half period of the actuator's resonant period (½ Tres) based on an amount of time that elapses between detection of the reference BEMF value at box 2106 and re-detection of the reference BEMF value at box 2110. If the search at box 2110 does not detect a BEMF value that matches the reference BEMF value before time ½ Tres, the search may continue for an additional amount of time, after which it times out (boxes 2116, 2118). If the search succeeds and a BEMF sample value is identified that matches the reference value, the method 2100 may advance to box 2114. If not, the method 2100 may enter a reset state (box 2120).

At box 2114, after the method 2100 has calculated ½ Tres based on measurements obtained during boxes 2106-2118, the method may advance to box 2122 and apply a driving current to the actuator in a second direction, opposite to the direction of current applied in box 2104. By reversing drive current, the method 2100 drives the actuator in a second half cycle of operation. The method 2100 may repeat operation of boxes 2106-2118 for the second half-cycle, shown as boxes 2124-2136 respectively.

Specifically, after application of the driving current in box 2122, the method 2100 may wait for a predetermined period of time and measure a BEMF level, taking the measured level to be a reference BEMF value (box 2124). The method 2100 may sample the BEMF value continuously thereafter and store maximum and minimum BEMF values until a predetermined amount of time has elapsed (box 2126). Again, the predetermined amount of time may be set to ⅝ths of the estimate of Tres. After the predetermined amount of time has elapsed, the method 2100 may continue to sample the BEMF values and search until time ½ Tres to detect a BEMF sample value that matches the reference BEMF value (boxes 2128, 2130). If a BEMF sample value is identified that matches the reference value, the method 2100 may estimate a half period of the actuator's resonant period (½Tres) based on an amount of time that elapses between detection of the reference BEMF value at box 2124 and re-detection of the reference BEMF value at box 2128 (box 2132). If the search at box 2110 does not detect a BEMF value that matches the reference BEMF value before time ½ Tres, the search may continue for an additional amount of time, after which it times out (boxes 2134, 2136). If the search succeeds and a BEMF sample value is identified that matches the reference value, the method 2100 may advance to box 2132. If not, the method 2100 may enter the reset state at box 2120.

At box 2132, after the method 2100 has calculated ½ Tres based on measurements obtained during boxes 2124-2136, the method may advance to box 2138 and calculate a final estimated value of Tres based on the calculations obtained at boxes 2114 and 2132. For example the final Tres estimate may be calculated as a moving average of prior Tres estimates, if any, obtained through prior iterations of the method 2100 and the new calculations. In one embodiment, the final Tres estimate may be calculated as:

$$Actual Tres = \frac{\begin{matrix}( History\_weight * Previous Tres ) + \\ ( \begin{matrix}New\_sample \_weight * \\ ( \frac{Tres}{2} Direction\_A + \frac{Tres}{2} Direction\_B )\end{matrix} )\end{matrix}}{History\_weight + New\_sample \_weight}$$

where the values History_weight and New_Sample_Weight are values that may be programmed by system designers and/or users. Thus, the method 2100 may provide programmable flexibility in determining the relative contributions of new Tres estimates and prior Tres estimates.

In the reset state, the method 2100 may put the driver into a high impedance state and the method 2100 may measure BEMF in the absence of active drive signals. The method 2100 may estimate a resonant period based on zero crossings of the BEMF signal with respect to ground. For example, the method 2100 may ensure that a predetermined number (say, 3) of zero crossings are detected, each of which should correspond to a half-period of the actuator's resonant period. The method 2100 may calculate Tres from the zero crossings and conclude reset operation, whereupon the method 2100 may advance to box 2012.

In an embodiment, the method 2100 may compare values of the BEMF signal to predetermined thresholds to determine whether to alter Tres estimates based on new calculations. For example, the method may compare maximum BEMF values obtained at boxes 2108 and/or 2126 to a predetermined threshold and, suspend operation of the method 2100 if these values do not exceed a predetermined minimum value. Terminating the method 2100 in this embodiment prevents the Tres estimate from changing when the BEMF values are too small to provide the basis for new estimates.

Several embodiments of the present invention are specifically illustrated and described herein. However, it will be appreciated that modifications and variations of the present invention are covered by the above teachings. In other instances, well-known operations, components and circuits have not been described in detail so as not to obscure the embodiments. It can be appreciated that the specific structural and functional details disclosed herein may be representative and do not necessarily limit the scope of the embodiments.

Those skilled in the art may appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be implemented, for example, using a computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disc Read Only Memory (CD-ROM), Compact Disc Recordable (CD-R), Compact Disc Rewriteable (CD-RW), optical disk, magnetic media, magneto-optical media, removable memory cards or disks, various types of Digital Versatile Disc (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

We claim:

1. A haptics control system, comprising:
a driver to generate a continuous drive signal to an output pin; and
a monitor, coupled to the output pin, to capture a Back Electromotive Force (BEMF) signal generated thereon, to measure a BEMF signal attribute, and to transmit an adjustment signal to the driver based on the BEMF signal attribute,
wherein the driver is configured to adjust the continuous drive signal generation according to the adjustment signal.

2. The haptics control system of claim 1, wherein the haptics control system is an integrated circuit.

3. The haptics control system of claim 1, wherein the BEMF signal attribute is a frequency of the BEMF signal.

4. The haptics control system of claim 1, wherein the BEMF signal attribute is an amplitude of the BEMF signal.

5. The haptics control system of claim 1, wherein the monitor comprises:
a DC canceller element to remove a DC offset corresponding to the drive signal from the captured signal;
an amplifier; and
an analog to digital converter.

6. The haptics control system of claim 5, wherein the monitor further comprises:
a rectifier to invert negative phases of the captured signal.

7. The haptics control system of claim 5, wherein the monitor further comprises:
a pair or resistors that mirror a resistance in the mechanical system.

8. The haptics control system of claim 5, wherein the monitor further comprises:
a rectifier to invert negative phases of the captured signal.

9. The haptics control system of claim 5, wherein the DC canceller element comprises:
a current source to produce a DC canceling current.

10. The haptics control system of claim 5, wherein the DC canceller element comprises:
a voltage source to produce a DC canceling current.

11. The haptics control system of claim 5, wherein the DC canceller element is implemented digitally.

12. The haptics control system of claim 1, wherein the BEMF signal attribute is a BEMF signal frequency, and the frequency is measured by capturing reference points corresponding to BEMF signal zero crossings.

13. The haptics control system of claim 1, wherein the BEMF signal attribute is the BEMF signal frequency, and the frequency is measured by capturing reference points corresponding to BEMF signal peak value.

14. The haptics control system of claim 1, wherein the BEMF signal attribute is the BEMF signal amplitude and the amplitude is measured by monitoring BEMF signal peak values.

15. The haptics control system of claim 1, wherein the driver is configured to operate in two modes, a switched drive mode to generate a switched drive signal and a linear drive mode to generate a linear drive signal.

16. The haptics control system of claim 15, wherein the driver is configured to operate in linear mode when the monitor is capturing the BEMF signal.

17. The haptics control system of claim 1, wherein the continuous drive signal is a current signal and the captured signal is a voltage signal.

18. The haptics control system of claim 1, wherein the continuous drive signal is a voltage signal and the captured signal is a current signal.

19. The haptics control system of claim 18, further comprising a sensing resistor.

20. The haptics control system of claim 1, wherein the continuous drive signal is a square wave drive signal.

21. The haptics control system of claim 1, wherein the continuous drive signal is a rhombic shaped drive signal.

22. The haptics control system of claim 1, wherein the continuous drive signal is a sinusoidal drive signal both saturated or not.

23. The haptics control system of claim 1, wherein the continuous drive signal is a multilevel pseudo sinusoidal drive signal.

24. The haptics control system of claim 22, wherein the monitor measures the BEMF signal when the sinusoidal drive signal's rate of current change is zero.

25. The haptics control system of claim 22, wherein the sinusoidal drive signal is a current signal.

26. The haptics control system of claim 22, wherein the sinusoidal drive signal is a voltage signal.

27. The haptics control system of claim 1, wherein the driver outputs the drive signal to a plurality of mechanical systems from the output pin/pins.

28. The haptics control system of claim 27, wherein the drive signal causes each mechanical system to vibrate to produce a haptic effect.

29. The haptics control system of claim 27, wherein the monitor captures a sum of all the BEMF signal's generated by the plurality of mechanical systems.

30. The haptics control system of claim 1, wherein the output pin includes a pair of pins for a differential continuous drive signal.

31. A method to generate a haptic effect, comprising:
generating a continuous drive signal;
outputting the continuous drive signal to an actuator via a signal line, wherein the continuous drive signal vibrates the actuator to generate a haptic effect;
capturing a BEMF signal generated by the actuator on the signal line during the application of the continuous drive signal;
measuring a BEMF signal property from the BEMF signal; and
adjusting a corresponding continuous drive signal property based on the measured BEMF signal property.

32. The method of claim 31, wherein the BEMF signal property is a BEMF signal frequency.

33. The method of claim 31, wherein the BEMF signal property is a BEMF signal amplitude.

34. The method of claim 31, wherein capturing the BEMF signal comprises removing a DC offset in a captured signal, wherein the DC offset corresponds to the drive signal.

35. The method of claim 31, further comprising amplifying the BEMF signal and converting the BEMF signal to digital values.

36. The method of claim 31, further comprising rectifying the captured signal to invert negative phases.

37. The method of claim 31, wherein the DC offset is removed in an analog domain.

38. The method of claim 31, wherein the DC offset is removed digitally.

39. The method of claim 31, wherein the BEMF signal property is the BEMF signal frequency and the frequency is measured by capturing reference points corresponding to BEMF signal zero crossings.

40. The method of claim 31, wherein the BEMF signal property is the BEMF signal frequency and the frequency is measured by capturing reference points corresponding to BEMF signal peak value.

41. The method of claim 31, wherein the BEMF signal property is the BEMF signal amplitude and the amplitude is measured by monitoring BEMF signal peak values.

42. The method of claim 31, further comprising:
generating the continuous drive signal as a switched drive signal in one mode and a linear drive signal in another mode.

43. The method of claim 42, wherein the method generates a linear drive signal when capturing the BEMF signal.

44. The method of claim 31, wherein the continuous drive signal is a current signal and the captured signal is a voltage signal.

45. The method of claim 31, wherein the continuous drive signal is a voltage signal and the captured signal is a current signal.

46. The method of claim 31, wherein the continuous drive signal is a square wave drive signal.

47. The method of claim 31, wherein the continuous drive signal is a rhombic shaped drive signal.

48. The method of claim 31, wherein the continuous drive signal is a sinusoidal drive signal.

49. The method of claim 31, wherein the continuous drive signal is a multilevel pseudo sinusoidal drive signal.

50. The method of claim 48, wherein the sinusoidal drive signal is saturated.

51. The method of claim 48, wherein capturing the BEMF signal when the sinusoidal drive signal's rate of current change is zero.

52. The method of claim 31, wherein the sinusoidal drive signal is a current signal.

53. The method of claim 31, wherein the sinusoidal drive signal is a voltage signal.

54. The method of claim 31, further comprising applying the continuous drive signal to a plurality of actuators via the signal line.

55. The method of claim 54, further comprising capturing a sum of all BEMF signals generated by the plurality of actuators on the signal line.

56. A haptics control system, comprising:
a driver to generate a continuous drive signal to an output pin; and
a monitor comprising:
an input coupled to the output pin,
a DC canceling element to separate a BEMF signal from the continuous drive signal,
an amplifier,
an analog to digital converter;
an output to transmit an adjustment signal;
wherein the driver is configured to adjust the continuous drive signal generation according to the adjustment signal.

57. The haptics control system of claim 56, wherein the monitor measures a BEMF signal property and generates the adjustment signal based on the BEMF signal property.

58. The haptics control system of claim 57 wherein the BEMF signal property is a frequency.

59. The haptics control system of claim 57, wherein the BEMF signal property is an amplitude.

60. The haptics control system of claim 56, wherein the haptics control system is an integrated circuit.

61. The haptics control system of claim 56, the DC canceling element is implemented using analog circuitry.

62. The haptics control system of claim 56, the DC canceling element is implemented digitally.

63. The haptics control system of claim 56, wherein the driver is configured to operate in two modes, a switched drive mode to generate a switched drive signal and a linear drive mode to generate a linear drive signal.

64. The haptics control system of claim 56, wherein the continuous drive signal is a current signal.

65. The haptics control system of claim 56, wherein the continuous drive signal is a voltage signal.

66. An electronic device comprising:
a haptics controller to generate instructions based on a desired haptic effect;
a driver to receive to the instructions and generate a continuous drive signal;
a linear resonant actuator, coupled to the driver, to receive the continuous drive signal from driver via a signal line and to vibrate a mass within the linear resonant actuator thereby generating the desired haptic effect; and
a monitor to capture a BEMF signal produced by the vibration on the signal line, to measure a BEMF signal property,
wherein the driver is configured to adjust generation of the continuous drive signal based on the measured BEMF signal property.

67. A method of estimating a resonant period of an actuator comprising:
in a first iteration,
supplying a drive current to the actuator in a first direction,
measuring, a predetermined time after supplying the first direction drive current, a reference BEMF value, and
after the BEMF value deviates from the reference BEMF value, searching for a first time when the BEMF value returns to the reference BEMF value;
in a second iteration,
supplying the drive current to the actuator in a second direction,
measuring, a predetermined time after supplying the second direction drive current, a reference BEMF value, and
after the BEMF value deviates from the reference BEMF value, searching for a second time when the BEMF value returns to the reference BEMF value; and
calculating the resonant period of the actuator based on the first and second times.
